(19) United States
(12) Patent Application Publication
(10) Pub. No.: US 2006/0003204 A1
(43) Pub. Date: Jan. 5, 2006

(54) Controlling fuel cell fuel purge in response to recycle fuel blower operating conditions

(76) Inventors: Christopher W. Callahan, Windsor Locks, CT (US); Praveen Narasimhamurthy, Vernon, CT (US); Christopher P. McCready, Highland Lakes, NJ (US)

Correspondence Address: M. P. Williams, 210 Main Street, Manchester, CT, 06040, US

(21) Appl. No.: 10/884,025

(22) Filed: Jul. 1, 2004

(51) Int. Cl. H01M 8/04

(52) U.S. Cl. 429/22; 429/13

(57) ABSTRACT

A fuel cell power plant fuel purge valve (26) is controlled in response to a parameter (40, 40a) of a fuel recycle blower which is indicative (20) of the recycle fuel impelled thereby, either alone or together with load current (33), pressure rise of the blower (50, 51), and temperature of the fuel recycle gas (44), to provide a pulse width modulation-control signal (28) controlling the purge valve.

### TECHNICAL FIELD

This invention relates to monitoring the operating conditions of a fuel cell recycle fuel blower, such as speed or current, to estimate the ratio of hydrogen to non-hydrogen gases in the recycle stream, thereby to control a fuel purge valve.

### BACKGROUND

It is well known that fuel cell power plants cannot be run at 100% fuel utilization, that is, providing the exact amount of fuel which is consumed in producing the desired electrical load, without resulting in fuel starvation at various regions of various fuel cells in the stack. Fuel cell starvation results in corrosion of the carbonaceous catalyst supports, resulting in reduced system power performance. To overcome this problem, recycling a portion of the fuel, which exits the anode fuel flow fields, to the inlets of the anode fuel flow fields provides overall fuel cell stack utilization of nearly 100%, while having a lower fuel cell utilization on a single pass, cell by cell basis.

It is also known that recycle fuel contains a depleted amount of hydrogen which is mixed with inerts, such as nitrogen which crosses over from the air in the cathode through the porous membrane electrolyte. To clear the anode of the inerts, and to assure inward flow of fresh hydrogen, purging is accomplished, either in a small, steady amount, or more typically by pulse purging; that is, opening the purge valve on a periodic, duty cycle basis. The rate of purging is typically determined during initial testing of fuel cell models, on the basis of the density of current being produced. Thereafter, purging is performed in a predetermined fashion as a function of fuel cell stack current density.

The problem with this method is that it fails to take into account surges and variations in nitrogen crossover due to changes in the membrane, performance losses in the fuel cell, and so forth.

To overcome these problems, the purge is purposely set somewhat high, providing a marginal purge to assure that the purge will be sufficient; this naturally reduces the efficiency of the overall system below that which could possibly be attained. If the purge gas is released into a cabinet containing the fuel cell systems, the marginal, extra purge also increases on the cabinet ventilation system which increases the noise level and the parasitic power loss.

### DISCLOSURE OF INVENTION

Objects of the invention include: a simple, effective control over fuel cell anode purge which does not require additional equipment; providing information on hydrogen flow through the anode of a fuel cell without the need of hydrogen sensors; providing improved startup and shutdown of fuel cell power plants; providing purge control in a fuel cell power plant which is responsive to actual conditions in the anode fuel flow; assuring adequate fuel flow in a fuel cell power plant without marginal extra flow; and fuel cell power plant anode purge which is responsive to actual gas composition of the anode gas flow.

The term “recycle blower” is used herein for convenience and is to be understood to include any suitable fuel recycle gas mover or impeller which returns at least a portion of gas exiting the fuel flow fields of a fuel cell to an inlet of fuel cell fuel flow fields. This term includes fan-like blowers, pumps, compressors and other suitable impellers.

According to the present invention, an operating condition of a fuel cell fuel recycle blower, such as speed or current, is utilized to control a fuel purge valve. According to the invention, pulse purging may be accommodated by controlling the pulse width modulation of a purge valve in response to recycle fuel blower speed, current pressure rise, temperature or current. In accordance with one embodiment of the present invention, density of recycle fuel in a recycle blower nominally operated at constant speed or with a constant drive signal, is estimated from parameters, such as recycle blower conditions including current, speed and pressure rise, recycle gas temperature, and load current. In accordance with one aspect of the invention, a function of fuel recycle blower speed(s) and recycle gas temperature (T) or load current (I), provides a calculated, estimated pressure rise, which is compared with the actual measured pressure across the recycle blower, the error thereof being used to alter or trim the load current signal used to control the fuel purge valve. An example is: aI+bS+cIS. However, other combinations of parameters related to fuel cell stack performance and the recycle blower may be used within the purview of the invention.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a simplified, stylized schematic illustration of the fuel portion of a fuel cell stack known to the prior art.

FIG. 2 is a simplified, stylized schematic illustration of the fuel portion of a fuel cell power plant utilizing a simple embodiment of the present invention.

FIG. 3 is a simplified, stylized schematic illustration of the fuel portion of a fuel cell power plant employing another embodiment of the invention.

FIG. 4 is a functional, illustrative diagram of an exemplary control methodology for the configuration of FIG. 3.

FIG. 5 is a fragmentary, simplified schematic illustrating that the recycle blower parameter used to control the purge valve may be blower motor current.

### MODE(S) FOR CARRYING OUT THE INVENTION

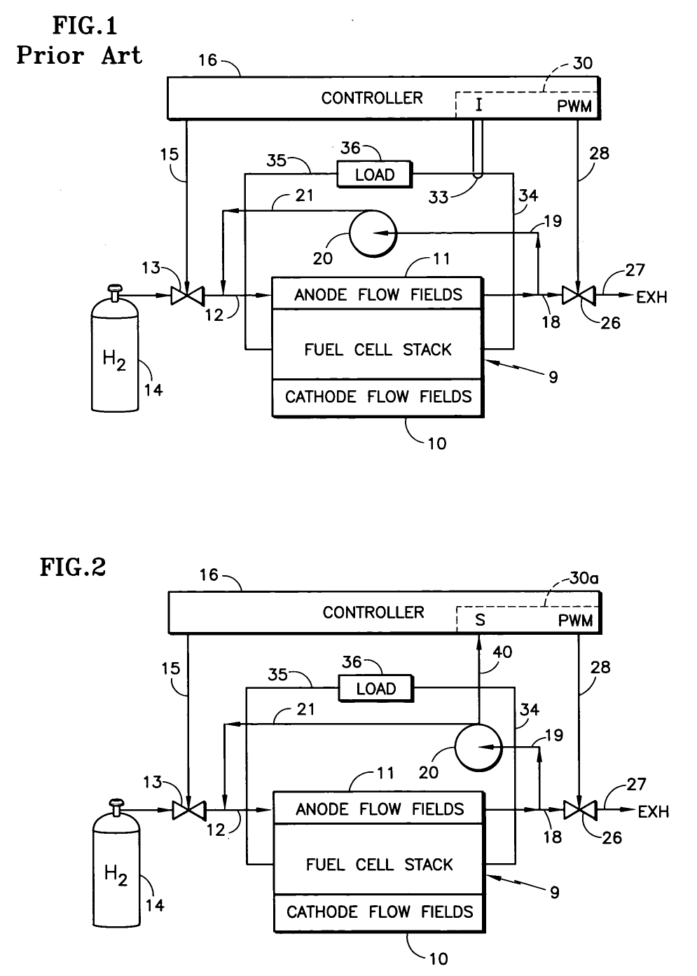

Referring to FIG. 1, a fuel cell stack 9 includes cathode flow fields 1 0, and includes anode flow fields 11 which are provided with fuel reactant gas in a fuel inlet conduit 12 through a valve 13 from a source 14 of fuel, such as hydrogen. The fuel exhaust in a conduit 18 provides fuel recycle gas in a conduit 19 to a recycle pump 20, the output of which is connected by a conduit 21 to the fuel inlet conduit 12, all as is known in the art. The valve 13 is controlled by a signal on a line 1 5 from a controller 16.

In order to control the amount of inert (non-fuel) gases in the anode flow fields 11, a purge valve 26 may periodically release small amounts of gas exiting the anode flow fields 11 to exhaust 27, which may be a suitably vented ambient or a burner, as is known. Control over the purge valve 26 may be in response to a pulse width modulation command on a signal line 28 from the controller 16 having a portion 30 that responds to current in the load to determine the amount of purge gas to expel from the system.

An indication of load current is provided by a sensor 33 in response to current in the fuel cell stack output lines 34, 35 that provide current to the load 36. In the known system of FIG. 1, the ratio of open and closed times is established in response to some function of load current which may be determined as appropriate for each type of fuel cell, or for each fuel cell if desired. However, the system in FIG. 1 does not take into account changes in the system over time, differences between one system and another, and particularly, the variation in nitrogen crossover which may occur depending upon operating conditions. The system of FIG. 1 also does not take into account rapid surges in load current and other perturbations in attempting to provide just the right amount of purge so as to achieve almost 100% overall fuel utilization without fuel starvation in any of the cells, and without unnecessary waste.

In FIG. 2, a simple embodiment of the present invention provides a signal on a line 40 indicative of the rotary speed, S, of the recycle blower 20, which is used in the function 30a of the controller 16 to determine the pulse width modulation signal on the line 28 to control the on/off operation of the purge valve 26, thereby controlling the average rate of purge of gas exiting from the anode flow fields. The function 30a may be an empirically determined monotonic function, either calculated in real time or stored in a look-up table.

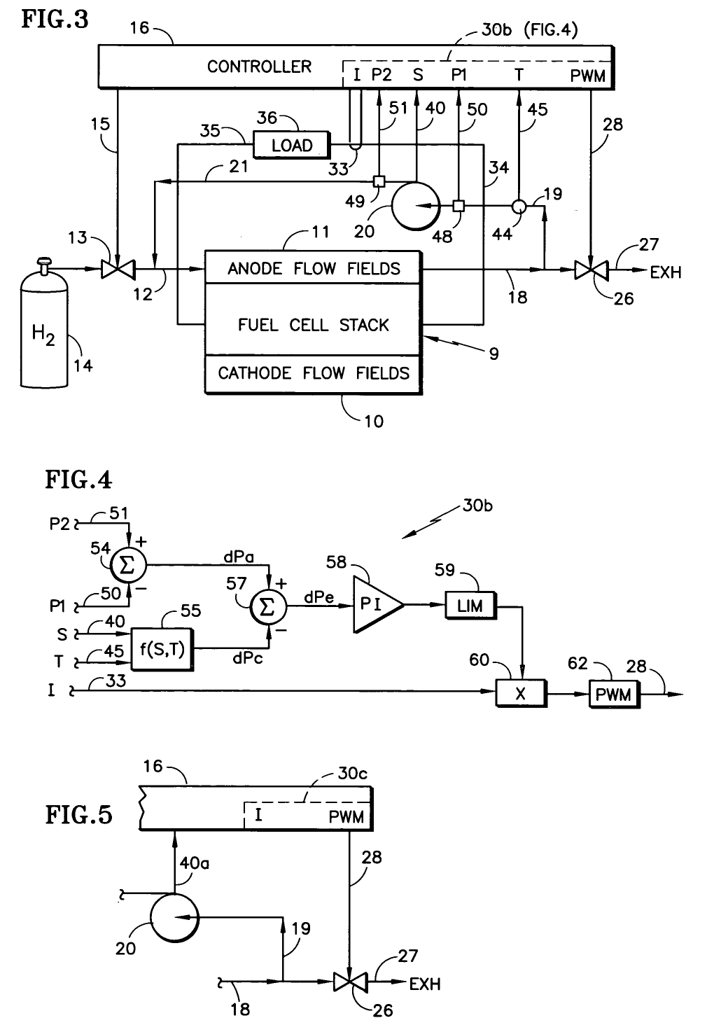

A more extensive version of the present invention is illustrated in FIG. 3. The configuration of FIG. 3 utilizes not only the current signal from the sensor 33 as in FIG. 1, and the speed signal on the line 40 as in FIG. 2, but also utilizes the temperature of the recycle gas determined by a temperature sensor 44 which provides a temperature signal on a line 45.

The configuration of FIG. 3 also responds to the pressure rise across the recycle pump 20 as determined by two pressure sensors 48, 49 providing signals on corresponding lines 50, 51 to the controller 16. The portion 30b of the controller is illustrated in FIG. 4. Therein, the actual, measured pressure rise of the recycle blower is determined by a summer 54 which subtracts the downstream pressure from the upstream pressure to provide the actual delta pressure, dPa. A function generator 55 generates an estimated correct pressure rise for the fuel cycle blower, dPc, in response to blower speed, S, and temperature of the recycle gas, T. The function 55 may, for example, be aI+bS+cIS. The difference between the actual pressure rise and the calculated pressure rise is determined by a summer 57 and the error, dPe, is applied to a proportional/integral amplifier 58, which has limits applied to the output thereof by a limit circuit 59, the output of which is fed to a multiplier 60. The functions of the summers 54, 57 may be combined. Although shown as discrete circuit blocks, the foregoing will typically be performed by software.

The effect of the multiplier 60 is, when the actual pressure rise is deemed proper for the current speed and temperature, the signal from the limit circuit 59 will be 1.0, causing the signal on the line 33 to be unaltered by the multiplier 60. If the actual pressure rise is greater than the estimated pressure rise, this indicates that there are more inerts in the fuel recycle stream than there should be, so that the multiplier 60 will increase the current signal by some amount greater than one. If the actual pressure rise is less than the estimated pressure rise, that means there is more hydrogen in the fuel recycle than is normal, so that the signal from the limiter 59 will reduce the current signal by a value which is slightly less than one. The multiplier 60 provides a signal to a conventional pulse width multiplier circuit (or function, in a computerized controller) 62 which provides the purge valve control signal on the line 28.

The foregoing embodiments utilize blower speed, which may typically be provided in terms of frequency (Hertz). However, the blower current may be utilized, instead, as an indication of the work performed by the blower, and therefore the density of the recycle gas, as illustrated by the line 40a in FIG. 5. The function in that case will be a slight variation of the function that is utilized with speed as the input.

Although the embodiments herein employ pulse width modulation of the purge valve, a valve may be continuously metered in response to a signal which is a function of the recycle blower condition indicative of density of the gas being impelled by the blower.

Thus, although the invention has been shown and described with respect to exemplary embodiments thereof, it should be understood by those skilled in the art that the foregoing and various other changes, omissions and additions may be made therein and thereto, without departing from the spirit and scope of the invention.

We claim:

1. A fuel cell power plant comprising:
a stack of fuel cells, each having anode fuel flow fields, each fuel flow field having an inlet and an outlet;
a controller;
a source providing hydrogen to the inlets of said fuel flow fields in response to said controller;
a recycle blower connected to the outlets of said fuel flow fields and providing recycle fuel to the inlets of said fuel flow fields;
a purge valve connected between the outlets of said fuel flow fields and exhaust, said exhaust selected from a burner or a vented ambient, said valve operated in response to said controller:
means for sensing a recycle blower parameter, indicative of the work required by said recycle blower as a function of the density of gas being impelled by said blower, and providing a parameter signal indicative thereof;
said controller responsive to said parameter signal for controlling the operation of said purge valve.

2. A fuel cell power plant according to claim 1 wherein said parameter is recycle blower speed.

3. A fuel cell power plant according to claim 1 wherein said parameter is recycle blower current.

4. A fuel cell power plant according to claim 1 wherein said controller, in controlling said purge valve, is also responsive to pressure rise across said blower, current through a load being powered by said fuel cell stack, and temperature of the fuel recycle gas for providing said parameter signal controlling said purge valve.

5. Apparatus for controlling a fuel purge valve in a fuel cell power plant, comprising:
means for sensing at least one parameter of a fuel recycle blower, selected from current and speed of said recycle blower, indicative of the density of gas being impelled thereby: and
means for controlling said fuel purge valve as a function of said parameter.

6. A method of controlling a fuel purge valve in a fuel cell power plant, comprising:
sensing at least one parameter of a fuel recycle blower, selected from current and speed of said recycle blower, indicative of the density of gas being impelled thereby: and
controlling said fuel purge valve as a function of said parameter.

7. A method according to claim 6 wherein said sensing step comprises:
sensing (I) current supplied to a load by said fuel cell power plant and (ii) speed of said recycle blower.

8. A method according to claim 6 wherein said sensing step comprises:
sensing pressure rise across said blower, current through a load being powered by said fuel cell stack, and temperature of the fuel recycle gas for providing said parameter signal controlling said purge valve.
